(19) United States
(12) Patent Application Publication
(10) Pub. No.: US 2021/0209088 A1
(43) Pub. Date: Jul. 8, 2021

(54) METHOD AND SYSTEM TO SUPPORT INDEXING IN ROW-GROUP COLUMNAR STORAGE

(71) Applicant: ALIBABA GROUP HOLDING LIMITED, George Town (KY)

(72) Inventors: Fang ZHENG, San Mateo, CA (US); Ruiping LI, San Mateo, CA (US); Cheng ZHU, San Mateo, CA (US); Congnan LUO, San Mateo, CA (US); Huaizhi LI, San Mateo, CA (US); Xiaowei ZHU, San Mateo, CA (US)

(21) Appl. No.: 16/733,121

(22) Filed: Jan. 2, 2020

(51) Int. Cl. G06F 16/22; G06F 16/245; G06F 9/38

(52) U.S. Cl. CPC G06F 16/2282; G06F 9/3836; G06F 16/245; G06F 16/221

(57) ABSTRACT

The present disclosure provides systems and methods for an indexing system in databases. One method for locating a row in a row-group columnar storage database comprises: receiving a query to locate a target row in the row-group columnar storage database that comprises rows of data divided into one or more blocks of data having columns of data that correspond to the rows of data, and one or more block information tables having column information corresponding to the columns of data in the one or more blocks of data, each block information table of the one or more block information tables being associated with a corresponding block of data of the one or more blocks of data; and locating the target row using the column information from the one or more block information tables.

### BACKGROUND

Increasing the sizes of databases has allowed for big data analysis, which is unlocking potentials in data and data querying. Many companies have developed row-group columnar storage databases to allow for quicker and more flexible accessing of data across a wide range of database queries. The conventional row-group columnar storage databases suffer from a significant drawback in that the databases do not have a comprehensive indexing structure that can provide support to query execution.

### SUMMARY

Embodiments of the present disclosure provides a method for creating indexing for row-group columnar storage in databases. The method comprises receiving a query to locate a target row in the row-group columnar storage database that comprises rows of data divided into one or more blocks of data having columns of data that correspond to the rows of data, and one or more block information tables having column information corresponding to the columns of data in the one or more blocks of data, each block information table of the one or more block information tables being associated with a corresponding block of data of the one or more blocks of data; and locating the target row using the column information from the one or more block information tables.

Moreover, embodiments of the present disclosure provide database systems for creating indexing for row-group columnar storage in databases. The database system comprises a row-group columnar storage database, comprising rows of data divided into one or more blocks of data having columns of data that correspond to the rows of data, and one or more block information tables having column information corresponding to the columns of data in the one or more blocks of data, each block information table of the one or more block information tables being associated with a corresponding block of data of the one or more blocks of data; a memory storing a set of instructions; and one or more processors configured to execute the set of instructions to cause the database system to receive a query to locate a target row in the row-group columnar storage database; and locate the target row using the column information from the one or more block information tables.

Moreover, embodiments of the present disclosure also provide non-transitory computer readable media that store a set of instructions that are executable by one or more processors of an apparatus to perform a method for creating indexing for row-group storage in databases. The method comprises receiving a query to locate a target row in the row-group columnar storage database that comprises rows of data divided into one or more blocks of data having columns of data that correspond to the rows of data, and one or more block information tables having column information corresponding to the columns of data in the one or more blocks of data, each block information table of the one or more block information tables being associated with a corresponding block of data of the one or more blocks of data; and locating the target row using the column information from the one or more block information tables.

### BRIEF DESCRIPTION OF THE DRAWINGS

The accompanying drawings, which are incorporated in and constitute a part of this specification, illustrate embodiments consistent with the invention and, together with the description, explain the principles of the invention.

FIG. 1 illustrates exemplary formats of storing data in a database.

FIG. 2 illustrates an exemplary format of row-group columnar storage in a database.

FIG. 3 illustrates an exemplary scan operation in a database.

FIG. 4 illustrates a schematic diagram of an exemplary server of a database system, according to some embodiments of the present disclosure.

FIG. 5 illustrates an exemplary format for row-group columnar storage, according to some embodiments of the disclosure.

FIG. 6 illustrates exemplary auxiliary tables for row-group columnar storage, according to some embodiments of the disclosure.

FIG. 7 illustrates an exemplary format for attributes of a SEGFILEINFO table in a row-group columnar storage database, according to some embodiments of the present disclosure.

FIG. 8 illustrates an exemplary format for attributes of a BLKDESC table in a row-group columnar storage database, according to some embodiments of the present disclosure.

FIG. 9 illustrates an exemplary BLKDESC table in a row-group columnar storage database, according to some embodiments of the present disclosure.

FIG. 10 illustrates an exemplary format of for fields of a position_info attribute in a row-group columnar storage database, according to some embodiments of the present disclosure.

FIG. 11 illustrates a flowchart of an exemplary method for locating a row in a row-group columnar storage database using auxiliary tables, according to some embodiments of the disclosure.

FIG. 12 illustrates a flowchart of an exemplary method for creating an index structure for a selected set of columns in a row-group columnar storage database using auxiliary tables, according to some embodiments of the disclosure.

FIG. 13 illustrates a flowchart of an exemplary method for index scanning for a selected set of columns in a row-group columnar storage database using auxiliary tables, according to some embodiments of the disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

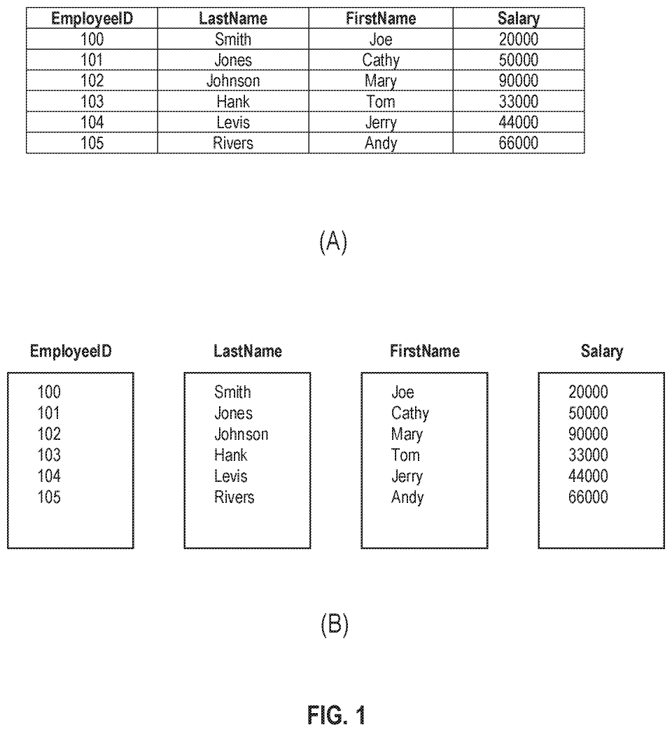

Many of the modern databases are columnar databases, which store data in columns rather than in rows. FIG. 1 illustrates exemplary formats of storing data in a database. As illustrated in FIG. 1(A), data can be logically represented as a two-dimensional table, which comprises columns and rows. The table shown in FIG. 1(A) has four columns and six rows. The columns are named “EmployeeID,” “LastName,” “FirstName,” and “Salary.” Data shown in the table can be stored in a number of ways. One way is called row-oriented storage. In row-oriented storage, data is stored row by row, and all the columns of a single row are physically placed together, similar to those shown in FIG. 1(A). The row-oriented storage is used for efficient access of data located in the same row. For example, if a user of a database system wishes to retrieve all column information associated with an entry “100” in the “EmployeeID” column, the user can easily retrieve entries “Smith,” “Joe,” and “20000” from the storage since these entries are physically stored together. Row-oriented storage is commonly used for transactional queries, such as online transactional processing (“OLTP”).

Another way to store data is called column-oriented storage. In column-oriented storage, data is stored column by column, and all the rows of a single column are physically placed together. As shown in FIG. 1(B), each column is stored separately. For example, all entries in the “EmployeeID” column are stored together. Sometimes, each column is usually further divided into blocks and each block is stored in compressed form. During query processing, data is read back from storage into memory in units of blocks.

The column-oriented storage is used to efficiently support analytical queries that are often interested in a subset of one or more columns. With the column-oriented storage, data of a particular column or a few columns can be retrieved without wasting input/output (“I/O”) bandwidth on columns that are not needed. In addition, column-oriented storage can allow for more efficient data compression because data in a column is typically of a same type. Column-orientated storage has demonstrated an ability to provide significant saving on I/O cost for many analytical queries, including online analytical processing (“OLAP”).

In many database systems featuring the column-oriented storage, data of all columns of a single row are spread out across the storage disk or multiple storage disks. For example, a block of one column's data can be stored in a specific location on a disk storage, and blocks of other columns' data may be stored in other locations that are not physically adjacent. As a result, accessing a particular row will require accessing multiple disk blocks spread across the storage disk or multiple storage disks, which can cause significant delay. Unfortunately, many typical OLTP queries often request such operations.

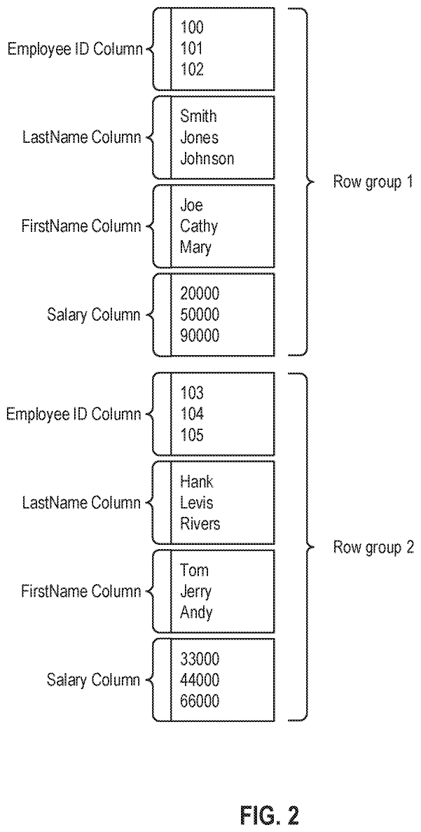

To address this inefficiency, some database systems adopt a row-group columnar storage or row-column hybrid storage. It first divides rows into row groups. A row group can also be called a block. The column-oriented storage is then used for each block. FIG. 2 illustrates an exemplary format of row-group columnar storage in a database. On the basis of the data illustrated in FIG. 1, the row-group columnar storage of FIG. 2 divides up the data into two blocks named row group 1 and row group 2. Row group 1 comprises the first three rows of data, and row group 2 comprises the next three rows of data. Data in each row group is then stored according to the column-oriented storage.

Depending on the size of the blocks, accessing a particular row in a row-group columnar storage can incur lower I/O costs than the pure column-oriented storage, because the column entries of a row are now located closer to each other. As a result, row-group columnar storage can perform well for OLTP queries. At the same time, the row-group columnar storage still gets a great deal of benefit of the column-oriented storage that is applied to each row group, because data inside each row group is still stored in a column-oriented storage. Therefore, the row-group columnar storage is often a good option for a mixed workload of OLTP and OLAP. In the following description, column-oriented storage is used to describe pure column-oriented storage and its row-column variant, and row-group columnar storage and row-column hybrid storage are used interchangeably.

Indexing is a data structure technique that can accelerate processing of queries in a database. An index can map values within one or more columns of a database table to the “EmployeeID” values of rows that have the corresponding values on the column(s). Indexing allows for fast lookup of rows with a given column value(s). Many of the major databases can support certain types of indexing. For example, B-Tree and bitmap indices are widely supported by many major databases.

To support indexing on a database table, each row in a database table has a unique row number as its identifier. One of the most logical way to assign row numbers is to number each row from the start of the database table and move downwards. For example, as shown in FIG. 1(A), the first row in the database table has a unique row number 0, the second row in the database table has a unique row number 1, and so on.

In an internal database implementation, each row's row number may be generated according to the internal database table storage. For example, in databases where rows of a table are stored in fixed-sized pages, each row's row number can be a 48-bit integer that is concatenated by a 32-bit page number and a 16-bit offset within the page.

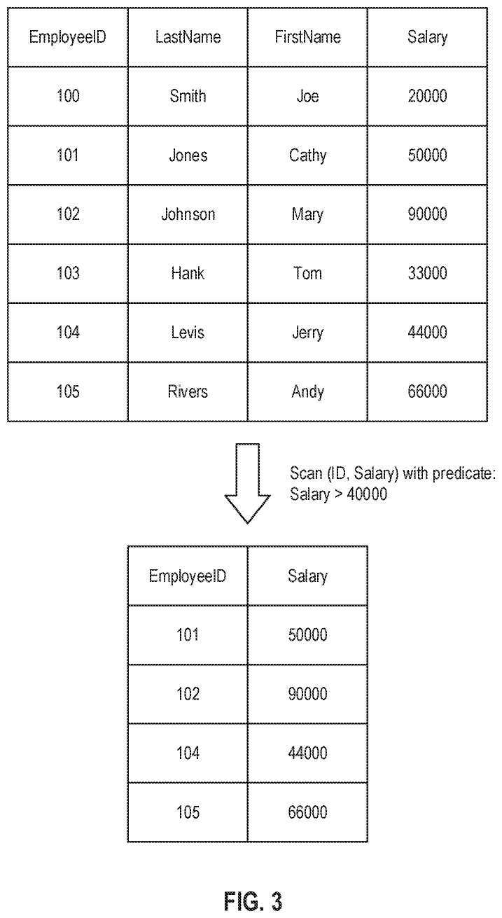

A scan operation is a primitive operation in database queries. A scan operation takes as input a table, and optionally a set of projected columns and a set of predicates, and outputs a set of projected rows in a database table that satisfies the given predicates. A predicate can be a conditional expression that evaluates to a Boolean value. FIG. 3 illustrates an exemplary scan operation in a database. According to FIG. 3, the scan has a predicate “Salary>40000” and a projection of (EmployeeID, Salary). To perform the scan operation, each row of the table is examined to check if the row satisfies the predicate. If the row satisfies, the selected columns in the projection is outputted. For example, the salary column in the second row reads 50000, which satisfies the “Salary>40000” predicate. As a result, (101, 50000) is outputted.

A point query is a query operation in databases. A point query finds rows having a set of columns in which values equal to certain given values. Indexing can be very useful in accelerating point queries. Since many columnar databases are designed for analytical workloads (e.g., OLAP) and point queries are not common in analytical workloads, it is not common for columnar database to support indexing. In fact, many popular columnar databases (such as Snowflake, Amazon Redshift, and Apache Hive) do not support any types of indexing. In these columnar databases where indexing is lacking, queries are processed by scanning the whole database table. Some of the columnar databases try to mitigate this issue by leveraging meta-data and data statistics to skip data blocks during a scan operation.

In many of the modern large-scale database systems, the database systems can be deployed on thousands of machines, and millions of analytical queries are routinely executed every day over peta-bytes of data that are stored across different machines and storage disks. These analytical queries can be either OLAP or OLTP. As a result, to handle the mixed workload at a peta-byte scale, large scale database systems can use a row-group columnar storage.

In addition, many of these large-scale database systems make heavy use of point queries. For example, in databases that specialize in ad targeting, point queries are heavily executed on large datasets using a combination of user's region, gender, age, or income. These queries can be executed much more efficiently with indexing on corresponding columns. As a result, there exists a need to support indexing in row-group columnar storage in order to provide real-time or near-real-time query responses.

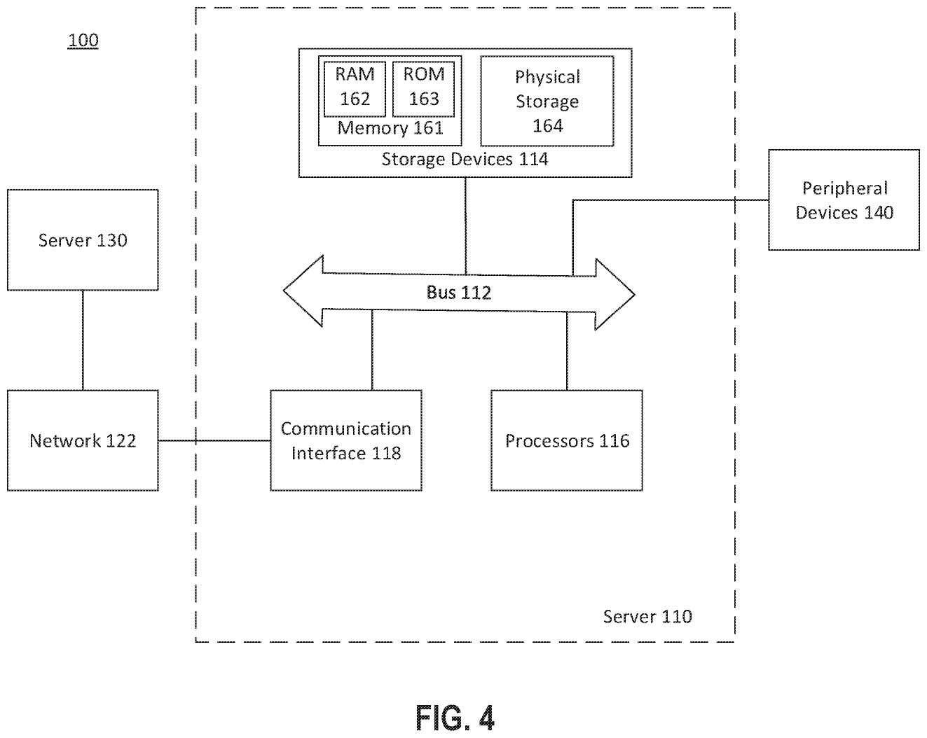

Embodiments of the present disclosure resolve these issues by creating and using indexing on row-group columnar storage. The types of indices that can be used in row-group columnar storage can include, for example, B-Tree, bitmap, hash, etc. FIG. 4 illustrates a schematic diagram of an exemplary server of a database system, according to some embodiments of the present disclosure. According to FIG. 4, server 110 of database system 100 comprises a bus 112 or other communication mechanism for communicating information, and one or more processors 116 communicatively coupled with bus 112 for processing information. Processors 116 can be, for example, one or more microprocessors. In some embodiments, database system 100 can be an OLAP database or an OLTP database.

Server 110 can transmit data to or communicate with another server 130 through a network 122. Network 122 can be a local network, an internet service provider, internet, or any combination thereof. Communication interface 118 of server 110 is connected to network 122. In addition, server 110 can be coupled via bus 112 to peripheral devices 140, which comprises displays (e.g., cathode ray tube (CRT), liquid crystal display (LCD), touch screen, etc.) and input devices (e.g., keyboard, mouse, soft keypad, etc.).

Server 110 can be implemented using customized hard-wired logic, one or more ASICs or FPGAs, firmware, or program logic that in combination with the server causes server 110 to be a special-purpose machine.

Server 110 further comprises storage devices 114, which may include memory 161 and physical storage 164 (e.g., hard drive, solid-state drive, etc.). Memory 161 may include random access memory (RAM) 162 and read only memory (ROM) 163. Storage devices 114 can be communicatively coupled with processors 116 via bus 112. Storage devices 114 may include a main memory, which can be used for storing temporary variables or other intermediate information during execution of instructions to be executed by processors 116. Such instructions, after being stored in non-transitory storage media accessible to processors 116, render server 110 into a special-purpose machine that is customized to perform operations specified in the instructions. The term “non-transitory media” as used herein refers to any non-transitory media storing data or instructions that cause a machine to operate in a specific fashion. Such non-transitory media can comprise non-volatile media or volatile media. Non-transitory media include, for example, optical or magnetic disks, dynamic memory, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, flash memory, register, cache, any other memory chip or cartridge, and networked versions of the same.

Various forms of media can be involved in carrying one or more sequences of one or more instructions to processors 116 for execution. For example, the instructions can initially be carried out on a magnetic disk or solid-state drive of a remote computer. The remote computer can load the instructions into its dynamic memory and send the instructions over a telephone line using a modem. A modem local to server 110 can receive the data on the telephone line and use an infra-red transmitter to convert the data to an infra-red signal. An infra-red detector can receive the data carried in the infra-red signal and appropriate circuitry can place the data on bus 112. Bus 112 carries the data to the main memory within storage devices 114, from which processors 116 retrieves and executes the instructions.

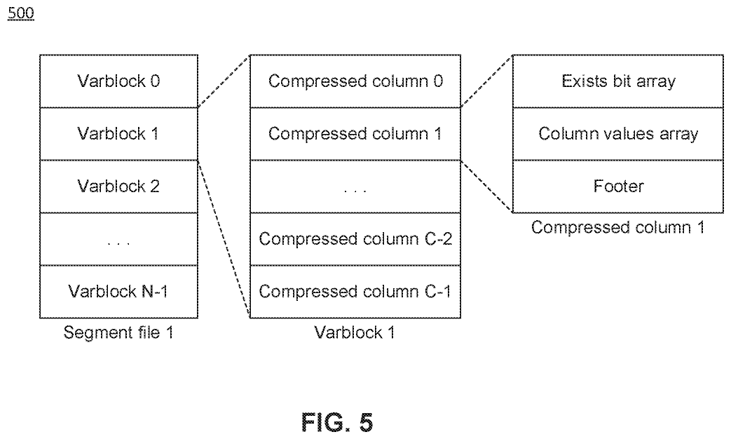

FIG. 5 illustrates an exemplary format for row-group columnar storage, according to some embodiments of the disclosure. It is appreciated that format 500 of FIG. 5 may be implemented in a database system (e.g., database system 100 of FIG. 4) or a server (e.g., server 110 of FIG. 4).

In FIG. 5, rows of a database table are stored in one or more segment files. For example, the table on the left of FIG. 5 is one segment file, named segment file 1. Each segment file can contain one or more blocks. As shown in FIG. 5, segment file 1 includes multiple blocks, namely varblock 0, varblock 1, varblock 2, etc. Each block can correspond to a row group, and each block can contain a number of rows. Rows in a block are organized in columnar storage. In other words, values in each column are compressed and stored together. For example, as shown in FIG. 5, varblock 1 includes rows that are organized in compressed columns, namely compressed column 0, compressed column 1, compressed column 2, etc. Other than storing the values in a column-values array, each column can also comprise an exists-bit array, which is a bitmap that indicates which value in the column is invalid (e.g., “NULL”). In addition, each column can comprise a footer that provides information about the column. The information from the footer can include compression methods used for column's values array and exist bits array.

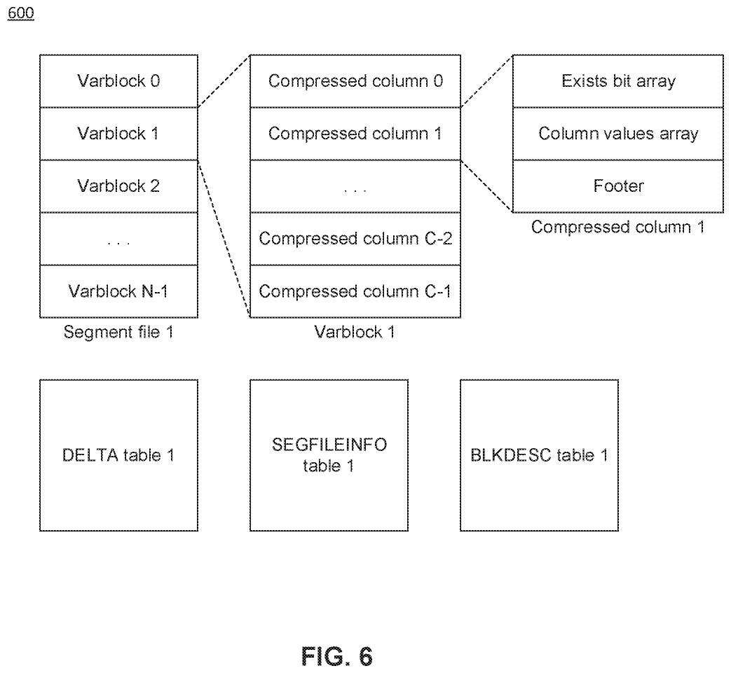

In some embodiments, for each database table stored in row-group columnar storage, a database system (e.g., database system 100 of FIG. 4) can create auxiliary row store tables, namely a new rows table (DELTA table), a segment file information table (SEGFILEINFO table), and a block information table (BLKDESC table). FIG. 6 illustrates exemplary auxiliary tables for row-group columnar storage, according to some embodiments of the disclosure. It is appreciated that SEGFILEINFO table format 600 of FIG. 6 can be implemented in a database system (e.g., database system 100 of FIG. 4).

As shown in FIG. 6, on the basis of format 500 of FIG. 5, format 600 further comprises three auxiliary tables, namely a DELTA table 1, a SEGFILEINFO table 1, and a BLKDESC table 1. The DELTA table 1 is used to store data that are newly added via insert operation or update operation in the database system. In some embodiments, the DELTA table 1 can have the same schema as the original database table. The SEGFILEINFO table 1 provides information for the database table's segment files. In some embodiments, the SEGFILEINFO table 1 can also generate row numbers. The BLKDESC table 1 can comprise various meta-data regarding the blocks in the segment files. In some embodiments, the BLKDESC table 1 can also locate a row by its row number.

In some embodiments, the DELTA table is automatically created by the database system when a database table stored in row-group columnar storage format is created. When data is added into the database table, the data is added into the DELTA table first. When a number of rows stored in the DELTA table reaches a threshold, a merge process is initiated to write the rows in the DELTA table into segment files in the database table. After the merge process, the DELTA table can be emptied. In some embodiments, the threshold of the DELTA table is configurable. In some embodiments, the merge process is a background process.

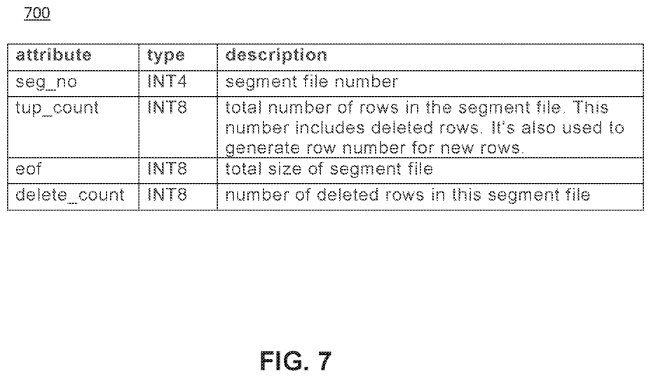

In some embodiments, the SEGFILEINFO table comprises information that describes the segment files in the database table. Each entry in the SEGFILEINFO table contains information that describes one segment file (e.g., segment file 1 of FIG. 5). Each entry can contain one or more attributes, with each attribute describing a specific aspect of the segment file. FIG. 7 illustrates an exemplary format for attributes of a SEGFILEINFO table in a row-group columnar storage database, according to some embodiments of the present disclosure. It is appreciated that SEGFILEINFO table format 700 can be implemented on SEGFILEINFO table 1 of FIG. 6. It is also appreciated that SEGFILEINFO table format 700 of FIG. 7 can be implemented in a database system (e.g., database system 100 of FIG. 4).

As shown in FIG. 7, each entry of the SEGFILEINFO table format 700 comprises a number of attributes, namely segment file number (seg_no), total number of rows in a segment file (tup_count), total data size (eof), and delete count. Each attribute can be a different data format, such as a 4-byte integer (INT4) or an 8-byte integer (INT8).

In some embodiments, data is written into segment files in bulks, using processes such as a merge process of the DELTA table or bulk loading operations. To support multiple concurrent writing operations, different writing operations may not write into the same segment file. Instead, each writing operation can be assigned a different segment file to write.

The total data size attribute (e.g., eof attribute of FIG. 7) can indicate a logical size of a segment file that covers the data written by the last committed writing operation. When a writing operation commits, the eof attribute is updated with a new offset, thus making the newly written data visible in the segment file. When a writing operation aborts, the eof attribute is not updated. As a result, the eof attribute still points to the offset before the writing operation initiates, and any newly written data in the segment file is unavailable, even if some or all of the newly written data is already in the segment file.

In some embodiments, SEGFILEINFO table format 700 can also comprise an attribute that describes the total number of rows in a segment file (tup_count). When a writing operation writes new rows into a segment file, the writing operation can retrieve the value of the tup_count attribute from the corresponding entry in the SEGFILEINFO table and can use the value of the tup_count attribute as a starting row number for the new rows. After the new rows are written into the segment file, the tup_count attribute is updated to cover the new rows.

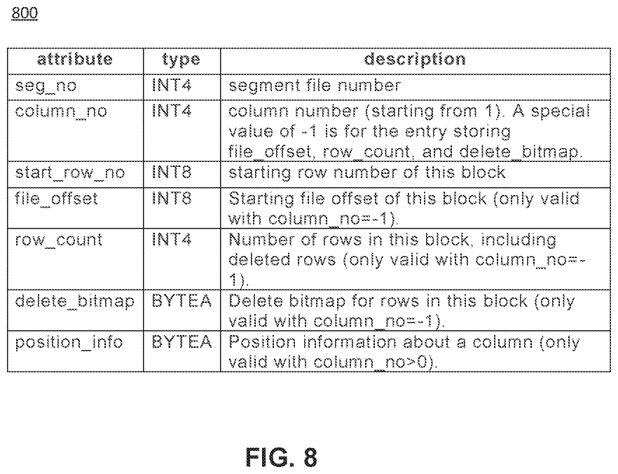

In some embodiments, the BLKDESC table comprises various meta-data regarding the blocks in the segment files. Each entry in the BLKDESC table contains information that describes one block file (e.g., varblock 1 of FIG. 5). Each entry can contain one or more attributes, with each attribute describing a specific aspect of the block file. FIG. 8 illustrates an exemplary format for attributes of a BLKDESC table in a row-group columnar storage database, according to some embodiments of the present disclosure. It is appreciated that BLKDESC table format 800 can be implemented on BLKDESC table 1 of FIG. 8. It is also appreciated that BLKDESC table format 800 of FIG. 8 can be implemented in a database system (e.g., database system 100 of FIG. 4).

As shown in FIG. 8, BLKDESC table format 800 comprises numerous attributes that describe a block file, including a segment file number (seg_no), column number (column_no), starting row number of the block (start_row_no), starting file offset of the block (file_offset), number of rows in the block (row_count), delete bitmap for rows in the block (delete_bitmap), and position information of a column in the block (position_info). In some embodiments, the column number (column_no) starts from value 1 and has a special value of −1 for an entry that stores attributes file_offset, row_count, and delete_map.

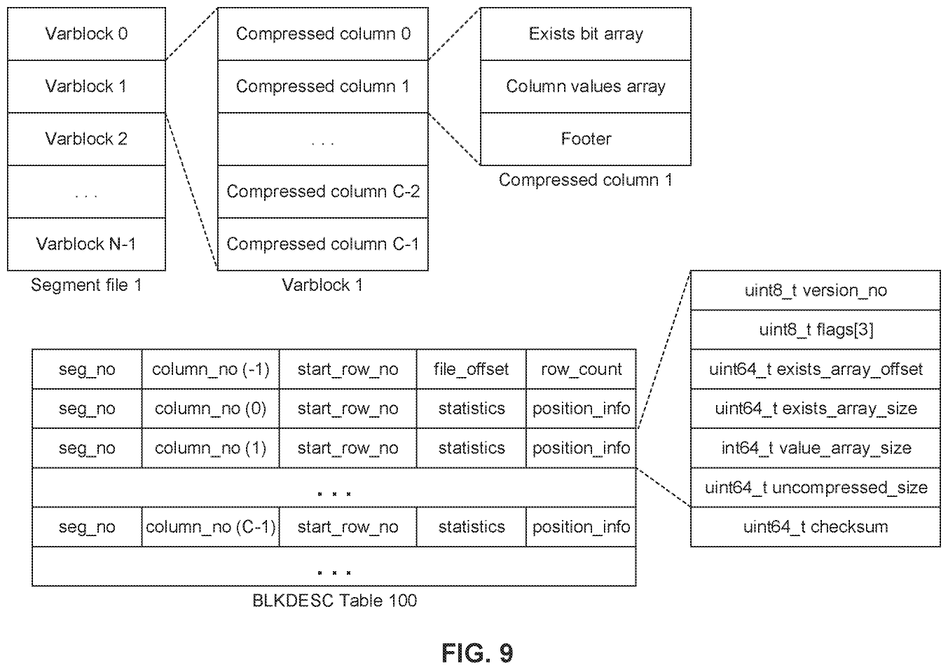

The BLKDESC tables can be implemented in row-group columnar storage database. FIG. 9 illustrates an exemplary BLKDESC table in a row-group columnar storage database, according to some embodiments of the present disclosure. The top portion of FIG. 9 illustrates an exemplary database table in row-group columnar storage, similar to format 500 of FIG. 5. It is appreciated that BLKDESC table 100 can implement BLKDESC format 800 of FIG. 8. It is also appreciated that the BLKDESC table 100 of FIG. 9 can be implemented in a database system (e.g., database system 100 of FIG. 4).

As shown in FIG. 9, each block (e.g., varblock 1) in a segment file (e.g., segment file 1) has multiple corresponding entries in BLKDESC table 100. Assuming that the database table has C columns, BLKDESC table 1 comprises C+1 entries, with an additional entry comprising attributes file_offset and row_count.

BLKDESC table 100 of FIG. 9 is organized in a format that is similar to BLKDESC table format 800 of FIG. 8. BLKDESC table 100 can comprise five columns, namely seg_no, column_no, start_row_no, statistics or file_offset, and position_info or row_count. The seg_no column can identify the segment file by providing a segment file number. The column_no can identify the columns by providing a column number. The start_row_no column can identify the starting row number of the block. The statistics column comprises statistical information of the column identified by the column_id in the block that is identified by block_id. In some embodiments, the statistical information can comprise minimum and maximum values in the column. The position_info column comprises location information of the column. In some embodiments, the position_info comprises column_offset and column_size. The column_offset entry identifies the relative location of the column inside the block. The column_size entry identifies the size of the column.

The BLKDESC table 100 of FIG. 9 also comprises a special entry with the column_no attribute equal to −1. This special entry comprises two attributes file_offset and row_count. The file_offset column can identify the starting file offset of the block in the segment file. The row_count column identifies the number of rows in the block. In some embodiments, the row_count column identifies the number of rows in the block, including the deleted rows. In some embodiments, the special entry can comprise attribute delete_bitmap. The delete_bitmap is an attribute that stores a bitmap, and each bit in the bitmap indicates whether a row in the block has been deleted.

In some embodiments, by implementing BLKDESC table 100 of FIG. 9, the database system can delete a row in a block by setting a corresponding bit in the delete_bitmap attribute of the block that contains the row. In addition, the database system can update a row in a block by setting a corresponding bit in the delete_bitmap attribute of the block that contains the row and by adding the updated row as a new row into the DELTA table.

In some embodiments, BLKDESC table 100 is an ordinary row-store table. To facilitate access to BLKDESC table 100, the database system can create indexing on the seg_no, start_row_no, and column_no attributes.

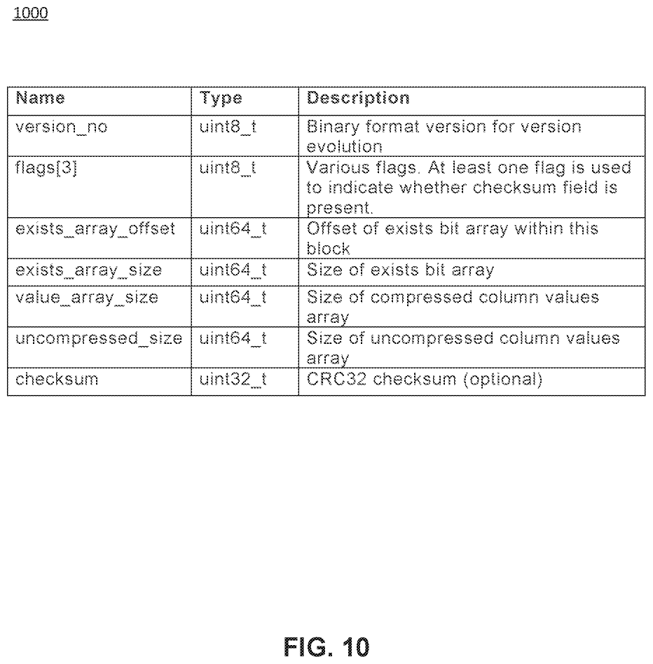

In some embodiments, the position_info attribute can comprise various fields that collectively record the location and size of the column in the block. FIG. 10 illustrates an exemplary format of for fields of a position_info attribute in a row-group columnar storage database, according to some embodiments of the present disclosure. It is appreciated that position_info format 1000 of FIG. 10 can be implemented in BLKDESC table format 800 of FIG. 8. It is also appreciated that the position_info format 1000 of FIG. 10 can be implemented in a database system (e.g., database system 100 of FIG. 4).

As shown in FIG. 10, position_info format 1000 comprises numerous fields that describe a block file, including binary format version (version_no), various flags (flags), offset of exists-bit array within the block (exists_array_offset), size of exists-bit array (exists_array_size), size of compressed column-values array (value_array_size), size of uncompressed column-values array (uncompressed_size), and an optional CRC32 checksum (checksum).

The auxiliary tables described above and their corresponding formats can provide new ways to assign row numbers in row-group columnar storage tables. In some embodiments, the row numbers in a row-group columnar storage table is a concatenation of the segment file number (seg_no) and the row number within the segment file, or segment file row number. In some embodiments, the latter is assigned using the SEGFILEINFO table's tup_count attribute when the row is inserted. In some embodiments, in order to make the row number format in row-group columnar storage compatible with existing indexing structures, the row number concatenates the segment file number and the row number within the segment file into an integer that is binary compatible with row number formats used by other row-store tables.

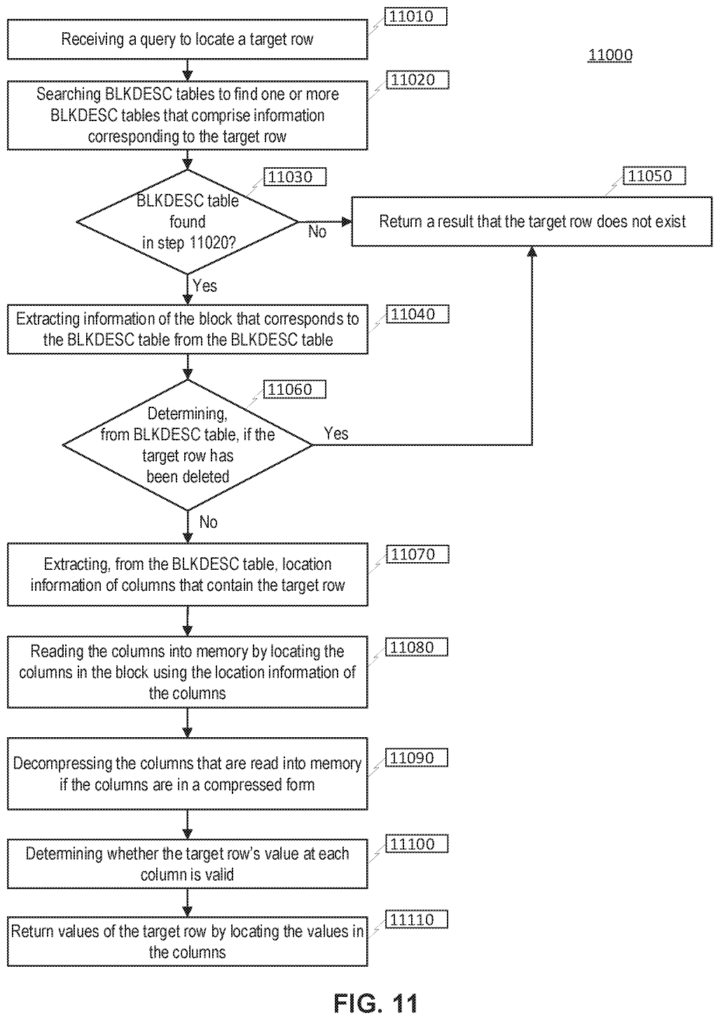

Embodiments of the present disclosure provides a method to locate a row in a row-group columnar storage database using auxiliary tables. FIG. 11 illustrates a flowchart of an exemplary method for locating a row in a row-group columnar storage database using auxiliary tables, according to some embodiments of the disclosure. It is appreciated that method 11000 of FIG. 11 may be performed by a database system (e.g., database system 100 of FIG. 4) or a server (e.g., server 110 of FIG. 4). It is also appreciated that method 11000 of FIG. 10 can operate on databases that use SEGFILEINFO table (e.g., SEGFILEINFO table 1 of FIG. 6) and BLKDESC table (e.g., BLKDESC table 1 of FIG. 6 or BLKDESC table 100 of FIG. 9).

In step 11010, a query is received to locate a target row. In some embodiments, the query comprises a row number for the target row, the row number being a concatenation of segment file number S and segment file row number R. In some embodiments, the query can be generated from a user of the database system, or the database system itself.

In step 11020, some or all of the database's BLKDESC tables are searched to find one or more target BLKDESC tables that comprise information corresponding to the target row. In some embodiments, the BLKDESC tables are searched to find if there is an entry where the seg_no attribute is equal to S, the start_row_no is less or equal to R, and the sum of the start_row_no and the row_count is larger than R. In some embodiments, the seg_no, start_row_no, and row_count attributes can be found in a special entry whose column_no attribute is equal to −1.

In step 11030, it is determined if a row is found in a target BLKDESC table whose attributes satisfies the conditions in step 11020. If a row is found in a BLKDESC table, it is determined that the BLKDESC table may contain information that corresponds to the target row, and step 11040 is executed. If none of the BLKDESC tables contain a row whose attributes satisfy the conditions above, step 11050 is executed, in which a result is returned (e.g., NULL) that the target row does not exist.

In step 11040, after it is determined in step 11030 that an entry in a BLKDESC table is found to satisfy the conditions listed in step 11020, information of the block that corresponds to the BLKDESC table is extracted from the BLKDESC table. In some embodiments, values of the start_row_no, row_count, and file_offset attributes are extracted from the entry. The value of the start_row_no attribute is represented by SR, and the value of the file_offset attributed is represented by FO. In some embodiments, the delete_bitmap attribute of the entry is also extracted.

In step 11060, it is determined from the BLKDESC table if the target row has been deleted from the block that corresponds to the BLKDESC table. In some embodiments, the delete_bitmap attribute is checked to determine if the target row has been deleted from the block. In some embodiments, the bit located at the location R minus start_row_no in the delete_bitmap attribute is checked to determine if the target row has been deleted. If it is determined that the target row has been deleted, step 11050 is executed, in which a result is returned (e.g., NULL) that the target row does not exist.

If it is determined that the target row has not been deleted, step 11070 is executed. In step 11070, location information of columns that contain the target row is extracted from the BLKDESC table. For each column i in the block that corresponds to the BLKDESC table, the BLKDESC table is traversed to find one or more entries that correspond to column i. In some embodiments, the BLKDESC is searched to find the entries where the seg_no attribute is equal to S, the start_row_no is equal to SR, and the column_no attribute is equal to i. In some embodiments, the value i covers a range of all entries in the BLKDESC table except for the special entry where the value i equals −1. The position_info attribute of each entry is then extracted. From the position_info, the offset and size of column i are determined. In some embodiments, the offset of column i can be determined as a sum of file_offset and exists_array_offset from the position_info attribute. In some embodiments, the size of column i is determined to be the size of the exists_array_size, the values_array_size, and the footer_size. In some embodiments, the footer_size is a fixed value (e.g., 8 bytes). As a result, it may not be necessary to store the footer_size,

In step 11080, using the location information of the columns, the columns can be located in the segment file and read from the segment file into memory. In other words, using column i's location information, column i of the block can be located in the segment file and read from the segment file into memory.

In step 11090, the columns that are read into memory can be decompressed if they are in a compressed form. In some embodiments, column i comprises an exists-bit array, a column-values array, and a footer. The exists-bit array and the column-values array can be decompressed according to compression methods recorded in the footer.

In step 11100, it is determined whether the target row's value at each column is valid. In other words, it is determined whether the target row's value at column i is valid (e.g., the value exists). In some embodiments, the exist bits array that is decompressed in step 11090 can be checked to determine whether the target row's value at column i exists. For example, a bit located at a location of R (value of the segment file row number) minus a value of the start_row_no attribute in the exist bits array is checked. If the bit is set to a value that indicates that the target row's value at column i is valid, then step 11110 is executed. If the bit is set to a value that indicates that the target row's value at column i is not valid (e.g., NULL), then a value indicating that that the value is invalid (e.g., NULL) is returned as the target row's value at column i.

In step 11110, after it is determined that the target row's value at column i is valid, the value is located in the decompressed column-values array and returned. In some embodiments, the value is located at a location of segment file row number minus the start_row_no in the decompressed column-values array.

Compared with the conventional database systems that use row-group columnar storage, method 11000 of FIG. 11 provides at least the following advantages. First, the existence of the target row can be checked right on the BLKDESC table without having to decompress any data stored in the segment files. For example, steps 11030 and 11060 are implemented to determine, from reading the BLKDESC tables, whether the target row exists or has been deleted. If it can be determined that the target row does not exist in memory, method 11000 can return this determination right away, and there is no more need to read and decompress any data in memory (e.g., steps 11080 and 11090). As a result, method 11000 can save valuable I/O resources that are otherwise wasted from reading and decompressing data. Second, because the BLKDESC table contains location information of the columns to be read, the columns can be easily located on the segment file. This allows the database system to optimize the reading operation, such as prefetching data using the location information of the columns.

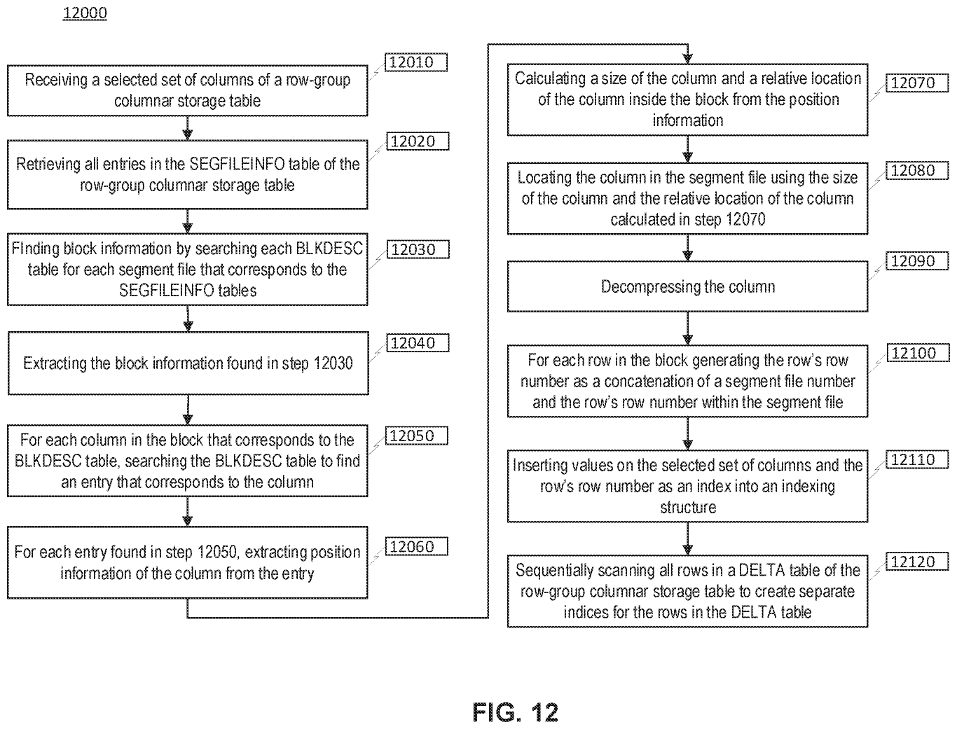

Embodiments of the present disclosure further provides a method to create indexing in a row-group columnar storage database using auxiliary tables. FIG. 12 illustrates a flowchart of an exemplary method for creating an index structure for a selected set of columns in a row-group columnar storage database using auxiliary tables, according to some embodiments of the disclosure. It is appreciated that method 12000 of FIG. 12 may be performed by a database system (e.g., database system 100 of FIG. 4) or a server (e.g., server 110 of FIG. 4). It is also appreciated that method 12000 of FIG. 11 can operate on databases that use SEGFILEINFO table (e.g., SEGFILEINFO table of FIG. 6) and BLKDESC table (e.g., BLKDESC table 1 of FIG. 6 or BLKDESC table 100 of FIG. 9).

In step 12010, a selected set of columns of a row-group columnar storage table is received. In some embodiments, the selected set of columns is received from a user. For example, the user may request the database to create an index on the “EmployeeID” and “Name” columns of the table shown in FIG. 1.

In step 12020, all entries in the SEGFILEINFO table of the row-group columnar storage table are retrieved by performing a sequential scan on the row-group columnar storage table. In some embodiments, a list is created for all segment file numbers that correspond to extracted entries in the SEGFILEINFO table.

In step 12030, for each segment file S in the row-group columnar storage table, a BLKDESC table of the segment file S is searched to find block information. In some embodiments, finding the blocking information includes searching a BLKDESC table of the segment file S to find a special entry in the BLKDESC table. In some embodiments, the entry is found using the following predicate: the seg_no attribute is equal to S, and the column_no attribute is equal to −1.

In step 12040, the block information found in step 12030 is extracted. In some embodiments, extracting the block information comprises extracting the attribute in the special entry for each special entry found in step 12030. In some embodiments, the attributes to be extracted comprises a starting row number of the block (e.g., start_row_no of BLKDESC table 100 in FIG. 9), a starting file_offset of the block (e.g., file_offset of BLKDESC table 100 in FIG. 9), or a number of rows in the block (e.g., row_count of BLKDESC table 100 in FIG. 9). In some embodiments, the value of the start_row_no attribute can be represented by SR, the value of the file_offset attribute can be represented by FO, and the value of the row_count attribute can be represented by RC.

In step 12050, for each column i in the selected set of columns, the BLKDESC table is searched to find an entry that corresponds to column i. In some embodiments, the searching of the BLKDESC table to find the entry that corresponds to column i involves finding an entry that satisfies the following predicate: the entry's seg_no attribute is equal to S, the entry's column_no attribute is equal to i, and the entry's start_row_no attribute is equal to SR.

In step 12060, for the entry found in step 12050, the entry's position_info attribute, which represents position information of column i in the block, is extracted. In some embodiments, the entry's position_info attribute comprises numerous fields, similar to position_info format 1000 of FIG. 10. More specifically, the entry's position_info can comprise binary format version (version_no), various flags (flags), offset of exists-bit array within the block (exists_array_offset), size of exists-bit array (exists_array_size), size of compressed column-values array (value_array_size), size of uncompressed column-values array (uncompressed_size), and an optional CRC32 checksum (checksum).

In step 12070, a size of column i and a relative location of column i inside the block can be calculated from the position_info attribute. In some embodiments, the relative location of the column (column_offset) can be calculated by adding FO and position_info attribute's exists_array_offset field. The size of column i (column_size) can be calculated by adding position_info attribute's exists_array_size field, position_info attribute's value_array_size field, and footer_size. In some embodiments, the footer_size is a fixed value (e.g., 8 bytes). As a result, it may not be necessary to store the footer_size,

In step 12080, using the size of column i and the relative location of column i from step 12070, column i can be located in the segment file and read from the segment file into memory. In some embodiments, column i comprises an exists-bit array (e.g., compressed column 1's exists-bit array of FIG. 5), a column-values array (e.g., compressed column 1's column-values array of FIG. 5), and a footer (e.g., compressed column 1's footer of FIG. 5).

In step 12090, the exists-bit array and the column-values array of column i are decompressed. In some embodiments, the exists-bit array and the column-values array are decompressed using compression methods recorded in the footer.

In some embodiments, steps 12050-12090 of method 12000 are executed for all blocks whose corresponding entry in the BLKDESC table satisfies the conditions in step 12050.

In step 12100, for each row in the block, the row's row number is generated as a concatenation of a segment file number of segment file S and the row's row number within the segment file. For example, the j-th row in the block has a row number of a sum of SR and j.

In step 12110, for each row in the block, values on the selected set of columns are inserted and the row's row number is inserted as an index into the index structure.

In some embodiments, steps 12030 to 12110 are executed for all segment files of the row-group columnar storage table in order to create indexing (e.g., indices) for rows in each segment files.

In step 12120, if the database comprises a DELTA table (e.g., DELTA table 1 of FIG. 6), all rows in a DELTA table of the row-group columnar storage table are sequentially scanned to create separate indices for the rows in the DELTA table.

In some embodiments, method 12000 can be applied to various indexing structures, such as B-Tree, hash index, etc.

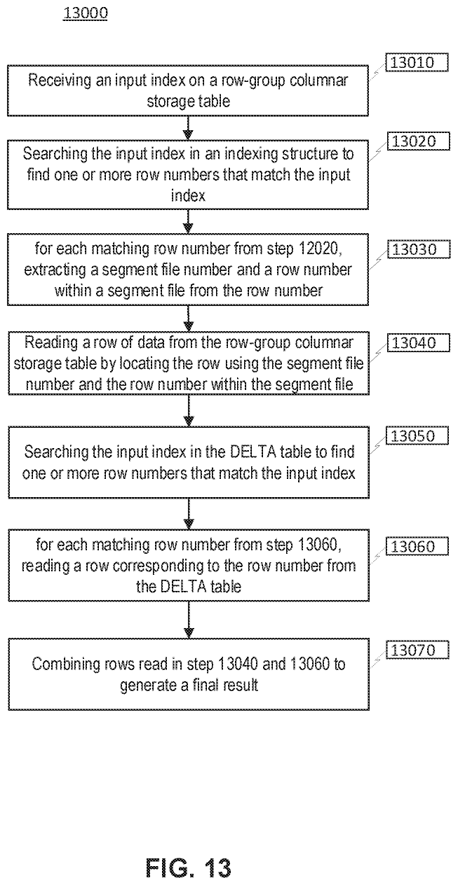

Embodiments of the present disclosure further provides a method to perform index scanning in a row-group columnar storage database using auxiliary tables. FIG. 13 illustrates a flowchart of an exemplary method for index scanning for a selected set of columns in a row-group columnar storage database using auxiliary tables, according to some embodiments of the disclosure. It is appreciated that method 13000 of FIG. 13 may be performed by a database system (e.g., database system 100 of FIG. 4) or a server (e.g., server 110 of FIG. 4). It is also appreciated that method 13000 of FIG. 13 can operate on databases that use SEGFILEINFO table (e.g., SEGFILEINFO table 1 of FIG. 6) and BLKDESC table (e.g., BLKDESC table 1 of FIG. 6 and BLKDESC table 100 of FIG. 9).

In step 13010, an input index on a row-group columnar storage table is received. In some embodiments, the input index is specific to a set of columns that was specified by a user when the index was created. For example, the user may request the database to create an index on the “EmployeeID” and “Name” columns of the table shown in FIG. 1. In some embodiments, the input index is located from a system catalog.

In step 13020, the input index is searched in an indexing structure to find one or more row numbers that match the input index.

In step 13030, for each matching row number, a segment file number and a row number within a segment file are extracted from the row number. In some embodiments, the row numbers in a row-group columnar storage table is a concatenation of the segment file number and the row number within the segment file. As a result, the segment file number and the row number within the segment file can be easily extracted by dividing the row number at a pre-defined location.

In step 13040, a row of data in the row-group columnar storage table is read according to the corresponding segment file number and the corresponding row number within the segment file. The row of data can also be referred to as a target row. In some embodiments, the row is read according to method 11000 of FIG. 11.

In step 13050, the input index from 13010 is searched in the DELTA table to find one or more row numbers that match the input index.

In step 13060, for each matching row number from step 13060, a row corresponding to the row number is read from the DELTA table.

In step 13070, the rows that are read from steps 13040 and 13060 are combined to generate a final result.

It is appreciated that the above described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. It is understood that multiple ones of the above described modules/units may be combined as one module/unit, and each of the above described modules/units may be further divided into a plurality of sub-modules/sub-units.

The embodiments may further be described using the following clauses:
1. A method for locating a row in a row-group columnar storage database, the method comprising:
receiving a query to locate a target row in the row-group columnar storage database that comprises:
   rows of data divided into one or more blocks of data having columns of data that correspond to the rows of data, and
   one or more block information tables having column information corresponding to the columns of data in the one or more blocks of data, each block information table of the one or more block information tables being associated with a corresponding block of data of the one or more blocks of data; and
locating the target row using the column information from the one or more block information tables.
2. The method of clause 1, wherein locating the target row using the column information from the one or more block information tables further comprising:
searching the one or more block information tables to find a target block information table that comprises column information corresponding to the target row; and
in response to a finding that there is a target block information table that comprises column information corresponding to the target row:
   extracting, from the target block information table, column information corresponding to the target row; and
   locating the target row using the column information corresponding to the target row.
3. The method of clause 2, wherein the column information in the one or more block information tables comprises location information of the one or more blocks and location information for columns in the one or more blocks, and the location information for the columns in the one or more blocks is relative to the location information of the one or more blocks.
4. The method of clause 3, wherein extracting, from the target block information table, column information corresponding to the target row further comprises:
extracting location information of the target block; and
extracting location information of the columns that correspond to the target row.
5. The method of clause 4, wherein locating the target row using the column information corresponding to the target row further comprises:
locating the target row according to the location information of the target block and the location information of the columns that correspond to the target row.
6. The method of any one of clauses 2-5, wherein:
the target row is identified by a row number, wherein the row number comprises location information of the target row; and
extracting, from the target block information table, column information corresponding to the target row further comprises finding the column information from the target block information table according to the location information of the target row.
7. The method of any one of clauses 2-6, wherein:
the rows of data of the row-group columnar storage database are divided into one or more segment files, and each segment file comprising blocks of data; and
the row-group columnar storage database further comprises one or more segment file information tables having segment file information corresponding to the one or more segment files.
8. The method of clause 7, wherein:
the target row is identified by a row number, wherein the row number comprises location information of the segment file that comprises the target row; and
extracting, from the target block information table, column information corresponding to the target row further comprises finding the column information from the target block information table using the location information of the segment file that comprises the target row.
9. The method of any one of clauses 2-8, further comprising:
determining, from the target block information table, if the target row has been deleted; and
in response to a determination that the target row has been deleted, returning the determination that the target row has been deleted.
10. The method of any one clauses 2-9, wherein locating the target row using the column information corresponding to the target row further comprising:
reading into memory the columns that correspond to the column information corresponding to the target row; and
returning data of the target row by locating the data in the columns.
11. The method of clause 10, further comprising:
determining, from the target block information table, if the data of the target row at each of the columns that correspond to the column information corresponding to the target row is valid; and
in response to a determination that the target row's data at a column is not valid, returning data that indicates that the data of the target row at the column is not valid.
12. The method of any one of clauses 2-11, further comprising:
in response to a finding that there is no target block information table that comprises information corresponding to the target row, returning the finding.
13. A database system, comprising:
a row-group columnar storage database, comprising:
   rows of data divided into one or more blocks of data having columns of data that correspond to the rows of data, and
   one or more block information tables having column information corresponding to the columns of data in the one or more blocks of data, each block information table of the one or more block information tables being associated with a corresponding block of data of the one or more blocks of data;
a memory storing a set of instructions; and
one or more processors configured to execute the set of instructions to cause the database system to:
   receive a query to locate a target row in the row-group columnar storage database; and
   locate the target row using the column information from the one or more block information tables.
14. The database system of clause 13, wherein the one or more processors are further configured to execute the set of instructions to cause the database system to:
search the one or more block information tables to find a target block information table that comprises column information corresponding to the target row; and
in response to a finding that there is a target block information table that comprises column information corresponding to the target row:
   extract, from the target block information table, column information corresponding to the target row; and
   locate the target row using the column information corresponding to the target row.
15. The database system of clause 14, wherein the column information in the one or more block information table comprises location information of the one or more blocks and location information for columns in the one or more blocks, and the location information for the columns in the one or more blocks is relative to the location information of the one or more blocks.
16. The database system of clause 15, wherein the one or more processors are further configured to execute the set of instructions to cause the database system to:
extract location information of the target block; and
extract location information of the columns that correspond to the target row.
17. The database system of clause 16, wherein the one or more processors are further configured to execute the set of instructions to cause the database system to:
locate the target row according to the location information of the target block and the location information of the columns that correspond to the target row.
18. The database system of any one of clauses 14-17, wherein:
the target row is identified by a row number, wherein the row number comprises location information of the target row; and
the one or more processors are further configured to execute the set of instructions to cause the database system to find the column information from the target block information table according to the location information of the target row.
19. The database system of any one of clauses 14-18, wherein:
the rows of data of the row-group columnar storage database are divided into one or more segment files, and each segment file comprising blocks of data; and
the row-group columnar storage database further comprises one or more segment file information tables having segment file information corresponding to the one or more segment files.
20. The database system of clause 19, wherein:
the target row is identified by a row number, wherein the row number comprises location information of the segment file that comprises the target row; and
the one or more processors are further configured to execute the set of instructions to cause the database system to find the column information from the target block information table using the location information of the segment file that comprises the target row.
21. The database system of any one of clauses 14-20, wherein the one or more processors are further configured to execute the set of instructions to cause the database system to:
determine, from the target block information table, if the target row has been deleted; and
in response to a determination that the target row has been deleted, return the determination that the target row has been deleted.
22. The database system of any one clauses 14-22, wherein the one or more processors are further configured to execute the set of instructions to cause the database system to:
read into memory the columns that correspond to the column information corresponding to the target row; and
return data of the target row by locating the data in the columns.
23. The database system of clause 22, wherein the one or more processors are further configured to execute the set of instructions to cause the database system to:
determine, from the target block information table, if the data of the target row at each of the columns that correspond to the column information corresponding to the target row is valid; and
in response to a determination that the target row's data at a column is not valid, return data that indicates that the data of the target row at the column is not valid.
24. The database system of any one of clauses 14-23, wherein the one or more processors are further configured to execute the set of instructions to cause the database system to:
in response to a finding that there is no target block information table that comprises information corresponding to the target row, return the finding.
25. A non-transitory computer readable medium that stores a set of instructions that is executable by one or more processors of a database system to cause the database system to initiate a method comprising:
receiving a query to locate a target row in the row-group columnar storage database that comprises:
   rows of data divided into one or more blocks of data having columns of data that correspond to the rows of data, and
   one or more block information tables having column information corresponding to the columns of data in the one or more blocks of data, each block information table of the one or more block information tables being associated with a corresponding block of data of the one or more blocks of data;
locating the target row using the column information from the one or more block information tables.
26. The non-transitory computer readable medium of clause 25, wherein the set of instructions that is executable by one or more processors of the database system to cause the database system to further perform:
searching the one or more block information tables to find a target block information table that comprises column information corresponding to the target row; and
in response to a finding that there is a target block information table that comprises column information corresponding to the target row:
   extracting, from the target block information table, column information corresponding to the target row; and
   locating the target row using the column information corresponding to the target row.
27. The non-transitory computer readable medium of clause 26, wherein the column information in the one or more block information table comprises location information of the one or more blocks and location information for columns in the one or more blocks, and the location information for the columns in the one or more blocks is relative to the location information of the one or more blocks.
28. The non-transitory computer readable medium of clause 27, wherein the set of instructions that is executable by one or more processors of the database system to cause the database system to further perform:
extracting location information of the target block; and
extracting location information of the columns that correspond to the target row.
29. The non-transitory computer readable medium of clause 28, wherein the set of instructions that is executable by one or more processors of the database system to cause the database system to further perform:
locating the target row according to the location information of the target block and the location information of the columns that correspond to the target row.
30. The non-transitory computer readable medium of any one of clauses 26-29, wherein:
the target row is identified by a row number, wherein the row number comprises location information of the target row; and
the set of instructions that is executable by one or more processors of the database system to cause the database system to further perform finding the column information from the target block information table according to the location information of the target row.
31. The non-transitory computer readable medium of any one of clauses 26-30, wherein:
the rows of data of the row-group columnar storage database are divided into one or more segment files, and each segment file comprising blocks of data; and
the row-group columnar storage database further comprises one or more segment file information tables having segment file information corresponding to the one or more segment files.
32. The non-transitory computer readable medium of clause 31, wherein:
the target row is identified by a row number, wherein the row number comprises location information of the segment file that comprises the target row; and
the set of instructions that is executable by one or more processors of the database system to cause the database system to further perform finding the column information from the target block information table using the location information of the segment file that comprises the target row.
33. The non-transitory computer readable medium of any one of clauses 26-32, wherein the set of instructions that is executable by one or more processors of the database system to cause the database system to further perform:
determining, from the target block information table, if the target row has been deleted; and
in response to a determination that the target row has been deleted, returning the determination that the target row has been deleted.
34. The non-transitory computer readable medium of any one of clauses 26-33, wherein the set of instructions that is executable by one or more processors of the database system to cause the database system to further perform:
reading into memory the columns that correspond to the column information corresponding to the target row; and
returning data of the target row by locating the data in the columns.
35. The non-transitory computer readable medium of clause 34, wherein the set of instructions that is executable by one or more processors of the database system to cause the database system to further perform:
determining, from the target block information table, if the data of the target row at each of the columns that correspond to the column information corresponding to the target row is valid; and
in response to a determination that the target row's data at a column is not valid, returning data that indicates that the data of the target row at the column is not valid.
36. The non-transitory computer readable medium of any one of clauses 26-35, wherein the set of instructions that is executable by one or more processors of the database system to cause the database system to further perform:
in response to a finding that there is no target block information table that comprises information corresponding to the target row, return the finding.
37. A method for creating indexing in a row-group columnar storage database, the method comprising:
receiving a selected set of columns of the row-group columnar storage database that comprises:
   rows of data divided into one or more blocks of data having columns of data that correspond to the rows of data, and
   one or more block information tables having block information corresponding to the one or more blocks of data and column information corresponding to the columns of data in the one or more blocks of data, each block information table of the one or more block information tables being associated with a corresponding block of data of the one or more blocks of data;
generating row numbers for the rows of data according to the block information corresponding to the one or more blocks of data that comprise the rows of data; and
creating indexing according to the row numbers and the selected set of columns.
38. The method of clause 37, wherein:
the rows of data of the row-group columnar storage database are divided into one or more segment files, wherein each segment file comprises blocks of data; and
the row-group columnar storage database further comprises one or more segment file information tables having segment file information corresponding to one or more segment files, the segment file information comprising segment file numbers that correspond to the one or more segment files and segment file row numbers that correspond to the rows of data within the one or more segment files.
39. The method of clause 38, wherein generating row numbers for the rows of data according to the block information corresponding to the one or more blocks of data that comprise the rows of data further comprising:
generating a row number for a row of data by concatenating a segment file number of a segment file that comprises the row of data and the segment file row number of the row of data.
40. The method of any one of clauses 37-39, wherein the column information in the one or more block information tables comprises location information of the one or more blocks and location information for columns in the one or more blocks.
41. The method of clause 40, wherein creating indexing according to the row numbers and the selected set of columns further comprising:
extracting location information of the selected set of columns from the one or more block information tables;
locating the selected set of columns in the row-group columnar storage database according to the location information of the selected set of columns; and
extracting values of the selected set of columns from the row-group columnar storage database.
42. The method of clause 41, wherein extracting values of the selected set of columns from the row-group columnar storage database further comprising:
reading the selected set of columns into a memory; and
decompressing the selected set of columns.
43. A database system, comprising:
a row-group columnar storage database, comprising:
   rows of data divided into one or more blocks of data having columns of data that correspond to the rows of data, and
   one or more block information tables having block information corresponding to the one or more blocks of data and column information corresponding to the columns of data in the one or more blocks of data, each block information table of the one or more block information tables being associated with a corresponding block of data of the one or more blocks of data;
a memory storing a set of instructions; and
one or more processors configured to execute the set of instructions to cause the database system to:
   generate row numbers for the rows of data according to the block information corresponding to the one or more blocks of data that comprise the rows of data; and
   creating indexing according to the row numbers and the selected set of columns.
44. The database system of clause 43, wherein:
the rows of data of the row-group columnar storage database are divided into one or more segment files, wherein each segment file comprises blocks of data; and
the row-group columnar storage database further comprises one or more segment file information tables having segment file information corresponding to one or more segment files, the segment file information comprising segment file numbers that correspond to the one or more segment files and segment file row numbers that correspond to the rows of data within the one or more segment files.
45. The database system of clause 44, wherein the one or more processors are further configured to execute the set of instructions to cause the database system to:
generate a row number for a row of data by concatenating a segment file number of a segment file that comprises the row of data and the segment file row number of the row of data.
46. The database system of any one of clauses 43-45, wherein the column information in the one or more block information tables comprises location information of the one or more blocks and location information for columns in the one or more blocks.
47. The database system of clause 40, wherein the one or more processors are further configured to execute the set of instructions to cause the database system to:
extract location information of the selected set of columns from the one or more block information tables;
locate the selected set of columns in the row-group columnar storage database according to the location information of the selected set of columns; and
extract values of the selected set of columns from the row-group columnar storage database.
48. The database system of clause 47, wherein the one or more processors are further configured to execute the set of instructions to cause the database system to:
read the selected set of columns into a memory; and
decompress the selected set of columns.
49. A non-transitory computer readable medium that stores a set of instructions that is executable by one or more processors of a database system to cause the database system to initiate a method comprising:
receiving a selected set of columns of the row-group columnar storage database that comprises:
   rows of data divided into one or more blocks of data having columns of data that correspond to the rows of data, and
   one or more block information tables having block information corresponding to the one or more blocks of data and column information corresponding to the columns of data in the one or more blocks of data, each block information table of the one or more block information tables being associated with a corresponding block of data of the one or more blocks of data;
generating row numbers for the rows of data according to the block information corresponding to the one or more blocks of data that comprise the rows of data; and
creating indexing according to the row numbers and the selected set of columns.
50. The non-transitory computer readable medium of clause 49, wherein:
the rows of data of the row-group columnar storage database are divided into one or more segment files, wherein each segment file comprises blocks of data; and
the row-group columnar storage database further comprises one or more segment file information tables having segment file information corresponding to one or more segment files, the segment file information comprising segment file numbers that correspond to the one or more segment files and segment file row numbers that correspond to the rows of data within the one or more segment files.
51. The non-transitory computer readable medium of clause 50, wherein the set of instructions that is executable by one or more processors of the database system to cause the database system to further perform:
generating a row number for a row of data by concatenating a segment file number of a segment file that comprises the row of data and the segment file row number of the row of data.
52. The non-transitory computer readable medium of any one of clauses 49-51, wherein the column information in the one or more block information tables comprises location information of the one or more blocks and location information for columns in the one or more blocks.
53. The non-transitory computer readable medium of clause 52, wherein the set of instructions that is executable by one or more processors of the database system to cause the database system to further perform:
extracting location information of the selected set of columns from the one or more block information tables;
locating the selected set of columns in the row-group columnar storage database according to the location information of the selected set of columns; and
extracting values of the selected set of columns from the row-group columnar storage database.
54. The non-transitory computer readable medium of clause 53, wherein the set of instructions that is executable by one or more processors of the database system to cause the database system to further perform:
reading the selected set of columns into a memory; and
decompressing the selected set of columns.
55. A method for index scanning in a row-group columnar storage database, the method comprising:
receiving an input index on the row-group columnar storage database that comprises:
   rows of data divided into one or more blocks of data having columns of data that correspond to the rows of data, an indexing structure comprising row numbers that corresponds to the rows of data;
   one or more block information tables having column information corresponding to the columns of data in the one or more blocks of data, the column information comprising row numbers information, and each block information table of the one or more block information tables being associated with a corresponding block of data of the one or more blocks of data;
searching the indexing structure to find one or more row numbers corresponding to the input index;
extracting column information corresponding to the input index from the one or more block information tables according to the one or more row numbers; and
locating target rows of data in the row-group columnar storage database using the column information corresponding to the input index, wherein the target rows corresponds to the one or more row numbers.
56. The method of clause 55, wherein:
the rows of data of the row-group columnar storage database are divided into one or more segment files, wherein each segment file comprises blocks of data;
the row-group columnar storage database further comprises one or more segment file information tables having segment file information corresponding to one or more segment files, the segment file information comprising segment file numbers that correspond to the one or more segment files and segment file row numbers that correspond to the rows of data within the one or more segment files; and
each row number of the row numbers that corresponds to a row of data is a concatenation of a segment file number of a segment file that comprises the row of data and the segment file row number of the row of data.
57. The method of clause 56, wherein extracting column information corresponding to the input index from the one or more block information tables according to the one or more row numbers further comprising:
dividing a row number of the one or more row numbers into a segment file number and a segment file row number;
locating a block information table according to the segment file number and the segment file row number; and
extracting the column information corresponding to the input index from the block information table.
58. The method of any one of clauses 55-57, wherein locating target rows of data in the row-group columnar storage database using the column information corresponding to the input index further comprising:
searching the one or more block information tables to find a target block information table that comprises column information corresponding to one of the target rows of data; and
in response to a finding that there is a target block information table that comprises column information corresponding to the one of the target rows of data:
   extracting, from the target block information table, column information corresponding to the one of the target rows of data; and
   locating the one of the target rows of data using the column information corresponding to the one of the target rows of data.
59. The method of clause 58, wherein the column information in the one or more block information tables comprises location information of the one or more blocks and location information for columns in the one or more blocks, and the location information for the columns in the one or more blocks is relative to the location information of the one or more blocks.
60. The method of clause 59, wherein extracting, from the target block information table, column information corresponding to the one of the target rows of data further comprises:
extracting location information of the target block; and
extracting location information of the columns that correspond to the one of the target rows of data.
61. The method of clause 60, wherein locating the one of the target rows of data using the column information corresponding to the one of the target rows of data further comprises:
locating the one of the target rows of data according to the location information of the target block and the location information of the columns that correspond to the one of the target rows of data.
62. The method of any one of clauses 58-61, further comprising:
determining, from the target block information table, if the one of the target rows of data has been deleted; and
in response to a determination that the one of the target rows of data has been deleted, returning the determination that the one of the target rows of data has been deleted.
63. The method of any one of clauses 58-62, wherein locating one of the target rows of data using the column information corresponding to the one of the target rows of data further comprising:
reading into memory the columns that correspond to the column information corresponding to the one of the target rows of data; and
returning one of the target rows of data by locating the data in the columns.
64. The method of clause 63, further comprising:
determining, from the target block information table, if the data of the one of the target rows of data at each of the columns that correspond to the column information corresponding to the one of the target rows of data is valid; and
in response to a determination that the data of the one of the target rows of data at a column is not valid, returning data that indicates that the data of the one of the target rows of data at the column is not valid.
65. The method of any one of clauses 58-64, further comprising:
in response to a finding that there is no target block information table that comprises information corresponding to the one of the target rows of data, returning the finding.
66. A database system, comprising:
a row-group columnar storage database, comprising:
   rows of data divided into one or more blocks of data having columns of data that correspond to the rows of data,
   an indexing structure comprising row numbers that corresponds to the rows of data;
   one or more block information tables having column information corresponding to the columns of data in the one or more blocks of data, the column information comprising row numbers information, and each block information table of the one or more block information tables being associated with a corresponding block of data of the one or more blocks of data;
memory storing a set of instructions; and
one or more processors configured to execute the set of instructions to cause the database system to:
   receive an input index on the row-group columnar storage database;
   search the indexing structure to find one or more row numbers corresponding to the input index;
   extract column information corresponding to the input index from the one or more block information tables according to the one or more row numbers; and
   locate target rows of data in the row-group columnar storage database using the column information corresponding to the input index, wherein the target rows correspond to the one or more row numbers.
67. The database system of clause 66, wherein:
the rows of data of the row-group columnar storage database are divided into one or more segment files, wherein each segment file comprises blocks of data;
the row-group columnar storage database further comprises one or more segment file information tables having segment file information corresponding to one or more segment files, the segment file information comprising segment file numbers that correspond to the one or more segment files and segment file row numbers that correspond to the rows of data within the one or more segment files; and
each row number of the row numbers that corresponds to a row of data is a concatenation of a segment file number of a segment file that comprises the row of data and the segment file row number of the row of data.
68. The database system of clause 67, wherein the one or more processors are further configured to execute the set of instructions to cause the database system to:
divide a row number of the one or more row numbers into a segment file number and a segment file row number;
locate a block information table according to the segment file number and the segment file row number; and
extract the column information corresponding to the input index from the block information table;
69. The database system of any one of clauses 66-68, wherein the one or more processors are further configured to execute the set of instructions to cause the database system to:
search the one or more block information tables to find a target block information table that comprises column information corresponding to one of the target rows of data; and
in response to a finding that there is a target block information table that comprises column information corresponding to the one of the target rows of data:
   extract, from the target block information table, column information corresponding to the one of the target rows of data; and
   locate the one of the target rows of data using the column information corresponding to the one of the target rows of data.
70. The database system of clause 69, wherein the column information in the one or more block information tables comprises location information of the one or more blocks and location information for columns in the one or more blocks, and the location information for the columns in the one or more blocks is relative to the location information of the one or more blocks.
71. The database system of clause 70, wherein the one or more processors are further configured to execute the set of instructions to cause the database system to:
extract location information of the target block; and
extract location information of the columns that correspond to the one of the target rows of data.
72. The database system of clause 71, wherein the one or more processors are further configured to execute the set of instructions to cause the database system to:
locate the one of the target rows of data according to the location information of the target block and the location information of the columns that correspond to the one of the target rows of data.
73. The database system of any one of clauses 69-72, wherein the one or more processors are further configured to execute the set of instructions to cause the database system to:
determine, from the target block information table, if the one of the target rows of data has been deleted; and
in response to a determination that the one of the target rows of data has been deleted, return the determination that the one of the target rows of data has been deleted.
74. The database system of any one of clauses 69-73, wherein the one or more processors are further configured to execute the set of instructions to cause the database system to:
reading into memory the columns that correspond to the column information corresponding to the one of the target rows of data; and
returning one of the target rows of data by locating the data in the columns.
75. The database system of clause 74, wherein the one or more processors are further configured to execute the set of instructions to cause the database system to:
determine, from the target block information table, if the data of the one of the target rows of data at each of the columns that correspond to the column information corresponding to the one of the target rows of data is valid; and
in response to a determination that the data of the one of the target rows of data at a column is not valid, returning data that indicates that the data of the one of the target rows of data at the column is not valid.
76. The database system of any one of clauses 69-75 wherein the one or more processors are further configured to execute the set of instructions to cause the database system to:
in response to a finding that there is no target block information table that comprises information corresponding to the one of the target rows of data, return the finding.
77. A non-transitory computer readable medium that stores a set of instructions that is executable by one or more processors of a database system to cause the database system to initiate a method comprising:
receiving an input index on the row-group columnar storage database that comprises:
   rows of data divided into one or more blocks of data having columns of data that correspond to the rows of data,
   an indexing structure comprising row numbers that corresponds to the rows of data;
   one or more block information tables having column information corresponding to the columns of data in the one or more blocks of data, the column information comprising row numbers information, and each block information table of the one or more block information tables being associated with a corresponding block of data of the one or more blocks of data;
searching the indexing structure to find one or more row numbers corresponding to the input index;
extracting column information corresponding to the input index from the one or more block information tables according to the one or more row numbers; and
locating target rows of data in the row-group columnar storage database using the column information corresponding to the input index, wherein the target rows corresponds to the one or more row numbers.
78. The non-transitory computer readable medium of clause 77, wherein:
the rows of data of the row-group columnar storage database are divided into one or more segment files, wherein each segment file comprises blocks of data;
the row-group columnar storage database further comprises one or more segment file information tables having segment file information corresponding to one or more segment files, the segment file information comprising segment file numbers that correspond to the one or more segment files and segment file row numbers that correspond to the rows of data within the one or more segment files; and
each row number of the row numbers that corresponds to a row of data is a concatenation of a segment file number of a segment file that comprises the row of data and the segment file row number of the row of data.
79. The non-transitory computer readable medium of clause 78, wherein the set of instructions that is executable by one or more processors of the database system to cause the database system to further perform:
dividing a row number of the one or more row numbers into a segment file number and a segment file row number;
locating a block information table according to the segment file number and the segment file row number; and
extracting the column information corresponding to the input index from the block information table;
80. The non-transitory computer readable medium of clause 79, wherein the set of instructions that is executable by one or more processors of the database system to cause the database system to further perform:
searching the one or more block information tables to find a target block information table that comprises column information corresponding to one of the target rows of data; and
in response to a finding that there is a target block information table that comprises column information corresponding to the one of the target rows of data:
   extracting, from the target block information table, column information corresponding to the one of the target rows of data; and
   locating the one of the target rows of data using the column information corresponding to the one of the target rows of data.
81. The non-transitory computer readable medium of clause 80, wherein the column information in the one or more block information tables comprises location information of the one or more blocks and location information for columns in the one or more blocks, and the location information for the columns in the one or more blocks is relative to the location information of the one or more blocks.
82. The non-transitory computer readable medium of clause 81, wherein the set of instructions that is executable by one or more processors of the database system to cause the database system to further perform:
extracting location information of the target block; and
extracting location information of the columns that correspond to the one of the target rows of data.
83. The non-transitory computer readable medium of clause 82, wherein the set of instructions that is executable by one or more processors of the database system to cause the database system to further perform:
locating the one of the target rows of data according to the location information of the target block and the location information of the columns that correspond to the one of the target rows of data.
84. The non-transitory computer readable medium of any one of clauses 80-83, wherein the set of instructions that is executable by one or more processors of the database system to cause the database system to further perform:
determining, from the target block information table, if the one of the target rows of data has been deleted; and
in response to a determination that the one of the target rows of data has been deleted, returning the determination that the one of the target rows of data has been deleted.
85. The non-transitory computer readable medium of any one of clauses 80-84, wherein the set of instructions that is executable by one or more processors of the database system to cause the database system to further perform:
reading into memory the columns that correspond to the column information corresponding to the one of the target rows of data; and
returning one of the target rows of data by locating the data in the columns.
86. The non-transitory computer readable medium of clause 85, wherein the set of instructions that is executable by one or more processors of the database system to cause the database system to further perform:
determining, from the target block information table, if the data of the one of the target rows of data at each of the columns that correspond to the column information corresponding to the one of the target rows of data is valid; and
in response to a determination that the data of the one of the target rows of data at a column is not valid, returning data that indicates that the data of the one of the target rows of data at the column is not valid.
87. The non-transitory computer readable medium of any one of clauses 80-86, wherein the set of instructions that is executable by one or more processors of the database system to cause the database system to further perform:
in response to a finding that there is no target block information table that comprises information corresponding to the one of the target rows of data, returning the finding.

Unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method. In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

What is claimed is:

1. A method for locating a row in a row-group columnar storage database, the method comprising:
receiving a query to locate a target row in the row-group columnar storage database that comprises:
rows of data divided into one or more blocks of data having columns of data that correspond to the rows of data, and
one or more block information tables having column information corresponding to the columns of data in the one or more blocks of data, each block information table of the one or more block information tables being associated with a corresponding block of data of the one or more blocks of data; and
locating the target row using the column information from the one or more block information tables.

2. The method of claim 1, wherein locating the target row using the column information from the one or more block information tables further comprising:
searching the one or more block information tables to find a target block information table that comprises column information corresponding to the target row; and
in response to a finding that there is a target block information table that comprises column information corresponding to the target row:
extracting, from the target block information table, column information corresponding to the target row; and
locating the target row using the column information corresponding to the target row.

3. The method of claim 2, wherein the column information in the one or more block information tables comprises location information of the one or more blocks and location information for columns in the one or more blocks, and the location information for the columns in the one or more blocks is relative to the location information of the one or more blocks.

4. The method of claim 3, wherein:
extracting, from the target block information table, column information corresponding to the target row further comprises:
extracting location information of the target block, and
extracting location information of the columns that correspond to the target row; and
locating the target row using the column information corresponding to the target row further comprises:
locating the target row according to the location information of the target block and the location information of the columns that correspond to the target row.

5. The method of claim 2, wherein:
the target row is identified by a row number, wherein the row number comprises location information of the target row; and
extracting, from the target block information table, column information corresponding to the target row further comprises finding the column information from the target block information table according to the location information of the target row.

6. The method of claim 2, wherein:
the rows of data of the row-group columnar storage database are divided into one or more segment files, and each segment file comprising blocks of data; and
the row-group columnar storage database further comprises one or more segment file information tables having segment file information corresponding to the one or more segment files.

7. The method of claim 6, wherein:
the target row is identified by a row number, wherein the row number comprises location information of the segment file that comprises the target row; and
extracting, from the target block information table, column information corresponding to the target row further comprises finding the column information from the target block information table using the location information of the segment file that comprises the target row.

8. A database system, comprising:
a row-group columnar storage database, comprising:
rows of data divided into one or more blocks of data having columns of data that correspond to the rows of data, and
one or more block information tables having column information corresponding to the columns of data in the one or more blocks of data, each block information table of the one or more block information tables being associated with a corresponding block of data of the one or more blocks of data;
a memory storing a set of instructions; and
one or more processors configured to execute the set of instructions to cause the database system to:
receive a query to locate a target row in the row-group columnar storage database; and
locate the target row using the column information from the one or more block information tables.

9. The database system of claim 8, wherein the one or more processors are further configured to execute the set of instructions to cause the database system to:
search the one or more block information tables to find a target block information table that comprises column information corresponding to the target row; and
in response to a finding that there is a target block information table that comprises column information corresponding to the target row:
extract, from the target block information table, column information corresponding to the target row; and
locate the target row using the column information corresponding to the target row.

10. The database system of claim 9, wherein the column information in the one or more block information table comprises location information of the one or more blocks and location information for columns in the one or more blocks, and the location information for the columns in the one or more blocks is relative to the location information of the one or more blocks.

11. The database system of claim 10, wherein the one or more processors are further configured to execute the set of instructions to cause the database system to:
extract location information of the target block;
extract location information of the columns that correspond to the target row; and
locate the target row according to the location information of the target block and the location information of the columns that correspond to the target row.

12. The database system of claim 9, wherein:
the target row is identified by a row number, wherein the row number comprises location information of the target row; and
the one or more processors are further configured to execute the set of instructions to cause the database system to find the column information from the target block information table according to the location information of the target row.

13. The database system of claim 9, wherein:
the rows of data of the row-group columnar storage database are divided into one or more segment files, and each segment file comprising blocks of data; and
the row-group columnar storage database further comprises one or more segment file information tables having segment file information corresponding to the one or more segment files.

14. The database system of claim 13, wherein:
the target row is identified by a row number, wherein the row number comprises location information of the segment file that comprises the target row; and
the one or more processors are further configured to execute the set of instructions to cause the database system to find the column information from the target block information table using the location information of the segment file that comprises the target row.

15. A non-transitory computer readable medium that stores a set of instructions that is executable by one or more processors of a database system to cause the database system to initiate a method comprising:
receiving a query to locate a target row in the row-group columnar storage database that comprises:
rows of data divided into one or more blocks of data having columns of data that correspond to the rows of data, and
one or more block information tables having column information corresponding to the columns of data in the one or more blocks of data, each block information table of the one or more block information tables being associated with a corresponding block of data of the one or more blocks of data;
locating the target row using the column information from the one or more block information tables.

16. The non-transitory computer readable medium of claim 15, wherein the set of instructions that is executable by one or more processors of the database system to cause the database system to further perform:
searching the one or more block information tables to find a target block information table that comprises column information corresponding to the target row; and
in response to a finding that there is a target block information table that comprises column information corresponding to the target row:
extracting, from the target block information table, column information corresponding to the target row; and
locating the target row using the column information corresponding to the target row.

17. The non-transitory computer readable medium of claim 16, wherein the column information in the one or more block information table comprises location information of the one or more blocks and location information for columns in the one or more blocks, and the location information for the columns in the one or more blocks is relative to the location information of the one or more blocks.

18. The non-transitory computer readable medium of claim 17, wherein the set of instructions that is executable by one or more processors of the database system to cause the database system to further perform:
extracting location information of the target block;
extracting location information of the columns that correspond to the target row; and
locating the target row according to the location information of the target block and the location information of the columns that correspond to the target row.

19. The non-transitory computer readable medium of claim 16, wherein:
the target row is identified by a row number, wherein the row number comprises location information of the target row; and
the set of instructions that is executable by one or more processors of the database system to cause the database system to further perform finding the column information from the target block information table according to the location information of the target row.

20. The non-transitory computer readable medium of claim 16, wherein:
the rows of data of the row-group columnar storage database are divided into one or more segment files, and each segment file comprising blocks of data; and
the row-group columnar storage database further comprises one or more segment file information tables having segment file information corresponding to the one or more segment files.
